(19) United States
(12) Patent Application Publication
(10) Pub. No.: US 2007/0255002 A1
(43) Pub. Date: Nov. 1, 2007

(54) Non-Covalent Bonding Agent for Carbon Nanotube Reinforced Polymer Composites

(75) Inventor: Nicolas A. Alba, Pittsburgh, PA (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC, GAINESVILLE, FL (US)

(21) Appl. No.: 10/598,158

(22) PCT Filed: Feb. 17, 2005
(86) PCT No.: PCT/US05/04946

§ 371 Date: May 21, 2007

Related U.S. Application Data
(60) Provisional application No. 60/545,415, filed on Feb. 18, 2004.

(51) Int. Cl. B32B 13/02

(52) U.S. Cl. 524/543; 524/847

(57) ABSTRACT

A non-covalent bonding agent for carbon nanotube-reinforced polymer composites. The composites includes a polymeric solid state continuous phase and one or more carbon nanotubes dispersed in the continuous phase. The carbon nanotubes are joined to the polymer through the use of a bonding agent that mechanically couples the polymer chains to the carbon nanotubes. The bonding agent is non-covalently bonded to the carbon nanotube in a manner that retains substantially all of the properties of the carbon nanotube material and therefore permitting the carbon nanotubes to reinforce the polymer composite. The polymer composites may include a variety of different base polymers and may be used in a variety of applications.

### CROSS-REFERENCE TO RELATED APPLICATIONS

This application claims priority to U.S. Provisional Patent Application No. 60/545,415, which was filed Feb. 18, 2004.

### STATEMENT REGARDING FEDERALLY SPONSORED RESEARCH OR DEVELOPMENT

Not applicable.

### FIELD OF THE INVENTION

The present invention is directed to carbon nanotube reinforced polymer composite materials and methods for making the same.

### BACKGROUND OF THE INVENTION

There is a never ending search for improved materials. Many of these improved materials are composite materials. Polymer composites including a polymer matrix having one or more additives, such as a particulate or fiber material, dispersed throughout the continuous polymer matrix are well known. The additive is often added to enhance one or more properties of the polymer, such as the tensile strength.

Composites are formed when various distinct materials are engineered together to create something new. The idea is to take best advantage of the strengths of each component material, while minimizing weaknesses. Composites may be engineered with unique physical properties to suit very distinct applications. Most contemporary composites are composed of a hard strengthening phase (such as glass fiber) blended with a pliable cohesive matrix phase (such as plastic). This allows the weaker matrix phase to be significantly strengthened without sacrificing low weight or other beneficial properties, such as toughness or flexibility. Ideally, the strengthening phase will have extremely high mechanical strength and modulus, extremely low density, and possess as small an element size as possible. This will allow the final composite to be strong yet light, and allow components to be produced of extremely small size.

With this in mind, carbon nanotubes become a very attractive option. A carbon nanotube is essentially a graphite sheet folded into a tubular shape. This structure retains the mechanical strength of the sheet axial to the orientation of the tube, but is very weak in the lateral direction. Studies have estimated the potential engineering axial modulus of these nanotubes to be between about 300 Gigapascals to 1 Terapascal. One of the strongest engineering polymer fibers known, SPECTRA®, possesses a modulus of roughly 300 Gigapascals. Efforts to harness this strength in any practical engineering application has thus far been largely unsuccessful, due to the great difficulties in producing nanotubes in pure form, and also in arranging them in a manner that may be utilized.

Recent efforts have shifted to combining nanotubes into a polymer matrix, much like a fiberglass composite, using carbon nanotubes in place of glass. Certain processing may create polymer threads with an aligned nanotube strengthening phase, but mechanical testing has shown limited improvements in strength compared to theoretical predictions. It is thought that insufficient bonding between the nanotube and polymer phases limits the transfer of stress between the respective phases, and thus the ability of the nanotube phase to reinforce the polymer phase of the composite.

Chemical substitution of active groups onto the nanotube structure has also been investigated as a possible way of improving bonding at the nanotube polymer interface. However, chemical substitution may significantly reduce the strength and adversely affect the unique characteristics of the nanotube structure, such as the electrical conductivity of the nanotube.

Accordingly, what is needed is a composition that reinforces polymer materials with carbon nanotubes without the disadvantages associated with prior art systems. Also what is needed is a method of forming carbon nanotube-reinforced polymer composites that maintain beneficial properties of the carbon nanotubes, thereby providing a strengthened polymer composite.

### SUMMARY OF THE INVENTION

The present invention provides carbon nanotube-reinforced polymer composites and a method of making these composites. The composites include a base polymer continuous phase and one or more carbon nanotubes dispersed in the continuous phase. The carbon nanotubes are joined to the polymer through the use of a bonding agent that mechanically couples the carbon nanotubes to the polymer. The bonding agent may be joined to the carbon nanotube using a non-covalent bond, thereby substantially retaining the properties of the carbon nanotubes and therefore permitting the carbon nanotubes to reinforce the polymer composite. The polymer composites may use a variety of different base polymers and may be used in a variety of applications.

Accordingly, in one aspect, the present invention provides a carbon nanotube polymer composite material that includes a polymeric solid state continuous phase having a plurality of polymer chains, a plurality of carbon nanotubes dispersed in the continuous phase, and a bonding agent for mechanically coupling the polymer chains to the nanotubes. The bonding agent joins the polymer chain to the nanotube and while also bonding to the nanotube surface in a manner that retains substantially all of the properties of the carbon nanotubes. The bonding agent may bond to the carbon nanotube surface using a non-covalent bond. The nanotubes may be single wall nanotubes (SWNTS) or multi wall nanotubes (MWNTS).

In another aspect, the present invention provides a method of forming carbon nanotube polymer composite materials, including the steps of mixing a bonding agent having active groups on each of its ends with a polymer solution to form a functionalized polymer solution comprising one of the ends of the bonding agent bonded to the polymer, and blending the functionalized polymer solution with a carbon nanotube material to form a nanotube polymer composite, wherein the other of the ends of the bonding agent is non-covalently bonded to the carbon nanotube.

### BRIEF DESCRIPTION OF THE DRAWINGS

A fuller understanding of the present invention and the features and benefits thereof will be obtained upon review of the following detailed description together with the accompanying drawings, in which:

FIG. 1 shows the structure of an exemplary bonding agent including a polymer bonding group bound to a nanotube non-covalent bonding group having a pyrenyl group, according to one embodiment of the invention.

FIG. 2 shows an alternate example of a non-covalent bonding group according to another embodiment of the present invention.

FIG. 3(a) shows a schematic of a composite according to one embodiment of the present invention where the bonding agent is incorporated into the polymer chain and forms a bridge to the nanotube, while FIG. 3(b) shows the bonding agent forming a bridge between a nanotube and a polymer chain without being incorporated in the polymer chain.

FIG. 4 shows a schematic of a carbon nanotube reinforced polymer composite including carbon nanotubes aligned in a continuous polymer phase, wherein the polymer is joined to the nanotube by bonding agent molecules.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of”.

The present invention provides a carbon nanotube polymer composite material that includes a polymeric solid state continuous phase including a plurality of polymer chains, a plurality of carbon nanotubes dispersed in the continuous phase, and a bonding agent for mechanically coupling the polymer chains to the nanotubes. The bonding agent is joined to both the polymer chain and to the nanotube.

Accordingly, in one embodiment, the polymer composites of the present invention utilize a bonding agent that is joined to one or more carbon nanotubes. As used herein, a “polymer composite” is a composite material including a continuous polymer phase and having a reinforcement structure embedded within the continuous polymer phase. In the present invention, the reinforcement structure includes carbon nanotubes. Carbon nanotubes are useful as they possess several bond structures, and they may be produced with a variety of lengths and diameters. In select embodiments, carbon nanotubes possess a calculated elastic modulus of 1 TPa, mechanical strength of 30 GPa, and a density of 1.35 g/cm³. In comparison, typical steels possess an elastic modulus of roughly 200 GPa, mechanical strength of 3-400 MPa, and density of 7.86 g/cm³. As a result, the carbon nanotubes used in the present invention may be used to greatly increase the strength of the polymer composite. The nanotubes may be single wall nanotubes (SWNTS), multi wall nanotubes (MWNTS), or a combination of SWNTS and MWNTS.

In addition to the carbon nanotubes, the polymer composites of the present invention also include the polymer portion of the composite. Polymers useful in the present invention may be selected from a broad range of polymers, depending on one or more factors, such as the intended application of the composite material. In alternative embodiments, the polymers may be selected from biocompatible polymers. These biocompatible polymers may be used in various applications, such as, for example, selected health care related applications. In beneficial embodiments, the polymers have higher average molecular weights as these higher molecular weight polymers generally have higher strengths, such that the resulting polymer composite has increased strength. Examples of polymers that may be used in the present invention include, but are not limited to, rubber, polyester, polystyrene, latex, polyethylene, epoxies, polyacrylates, or blends or combinations thereof. In alternative embodiments, the polymer may be one that cross-links with itself.

As discussed, for health care applications the polymer used is beneficially biocompatible and generally has one or more beneficial characteristics. Such polymers are usually chemically inert, noncarcinogenic, hypoallergenic, and/or generally mechanically stable. Regarding the use of the polymer in a polymer composite as an implant material, the material is beneficially selected such that it is not capable of being modified, either physically or chemically, by local tissue. As a result, the implant beneficially does not cause any inflammatory response at the site of implantation. Biocompatible synthetic and non-degradable polymers that may be used in the present invention include, but are not limited to, silicone elastomers, poly(ethylene-co-vinyl acetate), and polyacrylates, such as poly isobutylcyanoacrylate and poly isohexylcyanoacrylate, poly(methyl methacrylate), or combinations thereof.

As discussed, carbon nanotubes possess excellent mechanical properties. However, harnessing these properties in practical engineering applications has proven difficult. The awkward arrangement of the sheets of graphite that make up the nanotubes makes it very difficult for the nanotubes to realize their full application potential in engineering applications. In addition, carbon nanotubes are highly insoluble, form disordered clumps, and can currently only be grown to limited lengths. Also, their extremely small size makes them difficult to manipulate.

However, based upon the present invention, the carbon nanotubes may be utilized due to their high aspect ratio, small diameter, low weight, high mechanical strength, high thermal and stability in air, and/or high electrical and thermal conductivity. The carbon nanotubes may be utilized as high performance carbon fibers for high performance, multifunctional composites.

Nevertheless, carbon nanotube surfaces are generally not compatible with most polymers, and the nanotube strengthening phase does not form a stable, strong interface with the plastic phase. Thus, strength increase is minimal. As a result, the polymer composites of the present invention also include a bonding agent. Bonding agents are relatively short organic molecules possessing chemical groups that interact with both phases within the composite.

In contrast to previous efforts that have covalently bonded functional groups to a carbon nanotube to provide a selected characteristic to the resulting structure not available from the nanotube itself, the present invention provides a way to improve bonding between the nanotube surface and any number of polymer substrates without covalently bonding to the nanotube and, without reducing the beneficial characteristics of the carbon nanotubes. Covalent bonding is known to damage or otherwise change the π-π conjugated carbon nanotube structure. As such, the present invention, in one embodiment, utilizes a non-covalent bonding agent that includes a short polymer chain with active groups on each end. The non-covalent bonding agent is selected such that one end will non-covalently bond with the carbon nanotube strengthening phase, and the other end will bond to the polymeric continuous phase substrate material, either in a covalent manner or a non-covalent manner. The non-covalent bonding end may non-covalently bond to the nanotube using any non-covalent bonding mechanism including, but not limited to, electrostatic, hydrogen, van der Waals, p aromatic, or hydrophobic. In select embodiments of the present invention, the non-covalent bonding end may bond to the carbon nanotube using pi-bonding.

As noted above, the bonding agent used in the present invention may be a variety of molecular structures that include one end group that may bond to the polymer or be included in the polymer chain and another end group that is capable of non-covalently bonding to the surface of the nanotube in a manner that retains substantially all of the properties of the carbon nanotubes. Bonding agents may be designed to bind the nanotube and a given polymer of interest. For example, to impregnate a polymer fiber with a nanotube strengthening phase, a bonding agent having a polymer bonding group bound to a nanotube non-covalent bonding group may be synthesized.

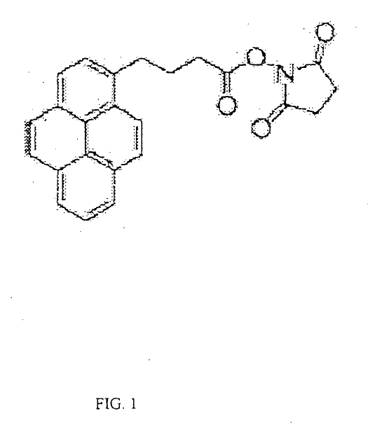

One example of a bonding agent that may be used in the present invention is the bonding agent disclosed in Chen et al. J. Am. Chem. Soc., 2001, 123, 3838 (hereafter Chen). The bonding agent disclosed in Chen is used in a method for bonding protein markers to nanotube surfaces using the bonding agent. FIG. 1 shows the structure of the bonding agent disclosed by Chen. However, the use of this bonding agent to form a polymer composites having increased strength due to carbon nanotube reinforcement is not recognized as Chen does not teach the polymer composites of the present invention, but rather uses proteins that have low strength such that the materials disclosed in Chen do not offer the increased strength of the polymer composites of the present invention.

The bonding agent shown in FIG. 1 includes, in one embodiment, a multifunctional molecule that includes a planar pyrenyl group. A planar pyrenyl group is a small piece of graphite sheet on one end and a polymer compatible active end group on the other end, the respective functional end groups bound together with a short alkane chain. The planar pyrenyl group is capable of non-covalently bonding to the surface of a carbon nanotube through a phenomenon known as r-stacking, wherein bonds within the pyrenyl structure interact strongly with π bonds within the carbon nanotube without altering the chemical structure or bonding arrangement of the nanotube. As a result, the carbon nanotube is not chemically altered and the strength properties of the carbon nanotube remain substantially intact.

Pi stacking more generally involves the overlap of π bonds between respective aromatic side chains. This results in electron delocalization and includes both side chains, This interaction produces an energy minimum which stabilizes the structure. A π-stacking attachment of a given bonding agent molecule to carbon nanotubes does not degrade the carbon nanotubes, in contrast to methods that involve covalent bonding. In addition, pi-stacking works with virtually any diameter nanotube and is inherent in the backbone of rigid conjugated polymers.

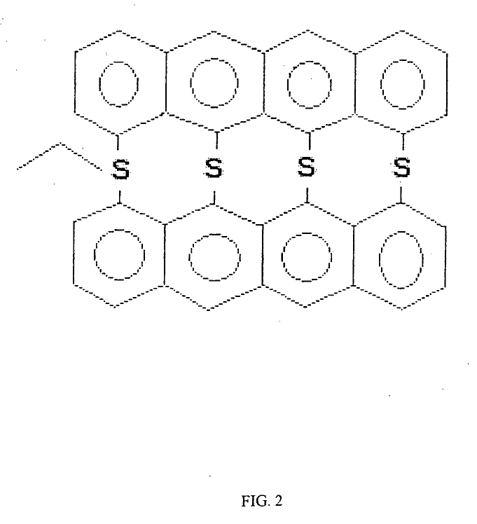

In an alternative embodiment of the present invention, the bonding agent may include aromatic end group moieties as these moieties may also be used to provide a pi-stacking interaction with the nanotube. FIG. 2 shows an example of a hypothetical sulfur containing aromatic, which may pi-stack with carbon nanotubes, such that it may be used as a bonding agent in the present invention.

The polymer compatible active group of the bonding agent is selected to interact with the bulk polymer continuous phase of the composite. Thus, the bonding agent may significantly improve the bonding characteristics between the polymer and the carbon nanotube, and thus improve the load transfer between the two phases (polymer and nanotube) within the composite. Both active ends of the bonding agent may be modified to suit the intended application.

The polymer composite according to the present invention may be formed using a variety of processing variants. In one embodiment, the bonding agent is added to the bulk polymer precursor, generally in the form of a monomer or oligomer solution. The carbon nanotubes may then added. The carbon nanotubes would then bond with the non-covalent active end of the bonding agent to form the polymer composite.

In an alternative embodiment, the bulk carbon nanotube material is pre-treated with the bonding agent and solvent to aid in nanotube separation and dispersion. The polymer precursor solution may then be blended with the nanotube solution.

The overall amount of carbon tubes added to the polymer composite may vary, depending on the selected application. In one embodiment, the carbon nanotubes make up from about 0.1 to about 80% by weight of the polymer composite. In another embodiment, the carbon nanotubes make up from about 0.5 to about 20% by weight of the polymer composite. In an exemplary embodiment, the final composite material includes from about 1.0% to about 10% of carbon nanotubes by weight.

The amount of bonding agent used is an amount sufficient to bond the selected amount of carbon nanotubes to the polymer. In selected embodiments, the amount of bonding agent used is selected such that an excess of bonding agent is provided.

Many polymers useful in the present invention, such as epoxies, do not generally require heating to complete polymerization. However, in some embodiments, the mixture may be heated to a suitable temperature to complete polymerization. Heating may also be used to help drive off any solvent used in the formation of the polymer composites. However, heating is not required and may be used depending on the polymer used, whether the bonding agent is polymerized to the polymer, and/or the selected characteristics of the final polymer composite.

In a particularly beneficial embodiments, the mixture may be subjected to high amounts of shear to form thin fiber, such as using a gel spinning technique or extrusion. In this embodiment, as the fiber is drawn, the nanotubes will orient themselves along the direction of shear, which will result in a strong load bearing orientation within the fiber. If performed correctly, the bonding agent will polymerize into the bulk polymer and associate itself along the surface of the nanotubes, resulting in improved load transfer across the interface, as seen in similar systems employing glass fiber or other contemporary composite systems. It may also be possible, in an alternative embodiment, to align nanotubes in the composite material using a magnetic field without using a mechanical shear.

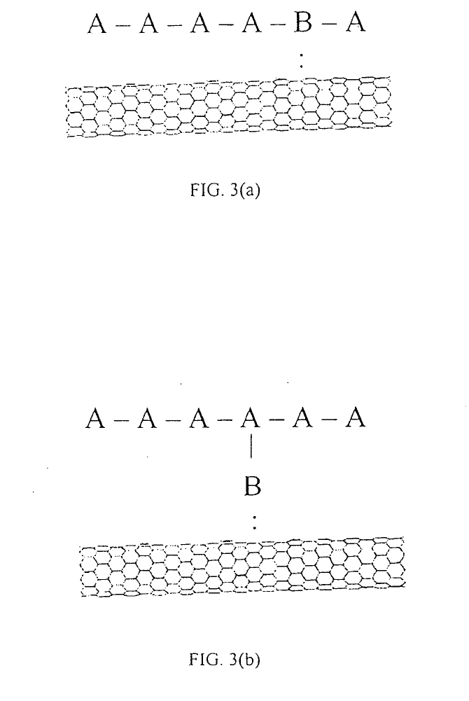

Depending on the particular bonding agent and the processing conditions, the bonding agent may be incorporated in the polymer structure to form a bridge between a polymer chain and a nanotube, or be both incorporated in the polymer structure, and provide bridges between the polymer and the nanotube. FIG. 3(a) shows a schematic of a composite according to the invention where the bonding agent (“B”) is incorporated into the polymer chain having a repeat unit denoted as “A”, while FIG. 3(b) shows the bonding agent (B) forming a bridge between the nanotube and a polymer chain (A-A-A) without the bonding agent being incorporated in the polymer chain.

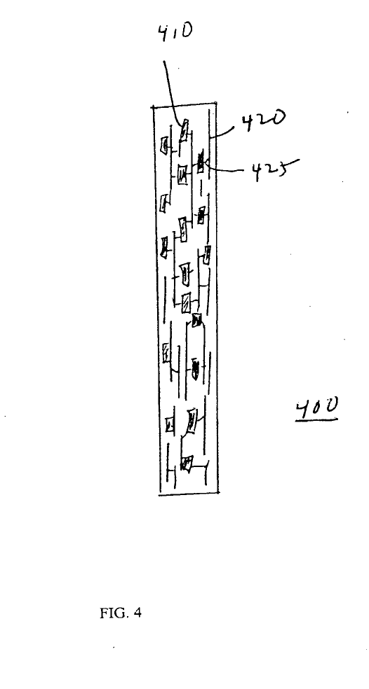

FIG. 4 shows a schematic of a carbon nanotube reinforced polymer composite rope section 400 including a plurality of carbon nanotubes 410 aligned in a continuous polymer phase comprising a plurality of polymer chains 420, where the polymer chains 420 is joined to the nanotube by bonding agent molecules 425. Some polymer chains 420 are shown mechanically coupling a given nanotube 410 to one or more other tubes 410. It is estimated that, in one embodiment, the strength of the reinforced composite material may be at least about 250 GPa. In an alternative embodiment, the strength of the reinforced composite material may be at least about 500 GPa, or more, depending on the particular polymer, bonding agent and nanotubes and percentages of each used, and the specific processing conditions utilized.

Although high-modulus polymer materials, including carbon-fiber reinforced composites are available, the polymer composites according to the present invention are structurally distinct and provide several significant advantages over these materials. For example, the materials of the present invention permit any number of different polymer materials to be used as the continuous phase, providing flexibility that may be tailored to specific end applications. Also, the nanotube strengthening phase may greatly increase the modulus and strength of the polymer base without contributing much, if anything, to density. Lastly, the polymer composites are formed in a manner that retains substantially all of the properties of the carbon nanotubes, thereby increasing the strength and/or conductivity properties of the polymer composite.

In addition, since the nanotube strengthening component is of a nano-size scale, there is no real limit to the size scale of the end product, and composite thread could conceptually be drawn as thin as practically possible without any loss of strengthening. The nearly atomic size scale of carbon nanotubes would permit the mechanism to be used to enhance the performance of even micro-sized components, allowing for the production of composite nano-wires of high strength. In addition, the inherent electrical conductance of pristine carbon nanotubes would provide a high degree of electrical conductivity to the composite as well, allowing for the possibility of high strength polymer electrical wire.

In addition, various engineering plastic, epoxy, and adhesive composites may also benefit from the present invention. The present invention may be used in a wide variety of applications, including high performance nano-composite fiber, which may be bound into cable or woven into fabric. Thus, potential end products include anything from fishing line to protective clothing, such as a bullet proof vest. Other applications for the present invention include, but are not limited to:

i) electrical applications including electronic circuits;

ii) thermal management (e.g. interface materials, spacecraft radiators, avionic enclosures and printed circuit board thermal planes);

iii) aircraft, ship, infrastructure and automotive structures;

iv) improved dimensionally stable structures for spacecraft and sensors;

v) reusable launch vehicle cryogenic fuel tanks and unlined pressure vessels;

vi) packaging of electronic, optoelectronic and microelectromechanical (MEMS) components and subsystems;

vii) fuel cells; and

viii) medical materials;

### EXAMPLES

It should be understood that the example and embodiments described herein are for illustrative purposes only and that various modifications or changes in light thereof will be suggested to persons skilled in the art and are to be included within the spirit and purview of this application. The invention may take other specific forms without departing from the spirit or essential attributes thereof.

As noted above, nanotube strengthening according to the invention may be used for a broad range of applications. The addition of a nanotube strengthening phase could substantially increase modulus of fiber without changing any of the beneficial aspects of the fiber, such as chemical resistance and compatibility with existing additives and coatings. Additionally, nanotubes may provide added strength without any increase in fiber density. Also, unlike other composite systems, nanotubes exist in the sub-micro scale, thus, fibers may be spun to very thin dimensions, yet retain the strengthening provided by the nanotubes.

Polymer fibers are commonly used for a wide variety of engineering applications, from braided cable for sports, to woven cloth for clothing, to formed reinforced objects such as helmets. In many of these applications, the key to improved performance is an increase in strength of the polymer fiber, or the ability to absorb energy before straining or breaking.

Bonding agents may be designed to bind the nanotube and a given polymer of interest. For example, to impregnate a polymer fiber with a nanotube strengthening phase, a bonding agent with the following structure may be synthesized:

(polymer bonding group)—(nanotube non-covalent bonding group)

Table 1 below provides examples of some thermoplastic polymer matrixes that have been incorporated into other bonding agents already in existence that may be adapted as shown above for use with the invention.

TABLE 1
Thermoplastics

| Class type of material to be | |
|---|---|
| coupled | Bonding Agent class |
| Cellulosics | amine |
| | isocyanate |
| | phosphate |
| Polyacetal | quaternary |
| | thiouronium |
| Polyacrylate | methacrylate |
| | ureido |
| Polyamine (nylon) | amine |
| | ureido |
| Polyamine-imide | amine |
| | chloromethylaromatic |
| Polybutylene terephthalate | amine |
| | isocyanate |
| Polycarbonate | amine |
| Polyetherketone | amine |
| (ethylene-vinyl acetate) | ureido |
| copolymer | |
| Polyethylene | amine |
| | styryl |
| | vinyl |
| Polyphenylene oxide | amine |
| | aromatic |
| Polyphenylene sulfide | amine |
| | chloromethylaromatic |
| | mercapto |
| Polypropylene | aromatic |
| | styryl |
| Polystyrene | aromatic |
| | epoxy |
| | vinyl |
| Polysulfone | amine |
| Polyvinyl butyral | amine |
| Polyvinyl chloride | amine |
| | alkanolamine |

As another example, if a manufacturer of polycarbonate fiber wishes to manufacture a stronger fiber using nanotubes, a bonding agent having an amine polymer bonding group on one end and a non-covalent nanotube bonding head on the other end may be used. The amine group would polymerize with the carbonate as the fiber is drawn under appropriate conditions. Thus, the bonding agent would serve as a physical link between the nanotubes and polycarbonate chains, and significantly strengthen the bonding between them, forming a stronger composite.

As yet another example, a manufacturer of nylon fiber may add a nanotube strengthening according to the invention in its product. The present invention may be used to provide a stronger nylon based fiber for advanced applications, while still maintaining nylon as the base material. One application for a reinforced nylon is for improved rope and fishing line.

Regarding nylon applications, a non-covalent bonding agent may be specifically designed for nylons, such as one based on an amine active group bound to a pyrenyl group through a short alkane chain. Bulk nanotube and the bonding agent may be incorporated into the fiber spinning process, and various parameters such as bulk nanotube and bonding agent weight contents may be adjusted to achieve the selected performance and cost of the final fiber. Given the proper incorporation of the optimum quantities of bulk nanotube and bonding agent, a fiber may be produced that substantially maintains the same weight, proportions, and chemical behavior of the original fiber, yet possesses substantially greater tensile modulus and toughness. The present invention is capable, in certain embodiments, of adding modulus to even some of the strongest engineering polymers known, such as ultra-high molecular weight polyethylene (UHMWPE), and make them even stronger without sacrificing low weight.

While various embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. A carbon nanotube polymer composite material, comprising:
a polymeric solid state continuous phase comprising one or more polymer chains;
one or more carbon nanotubes dispersed in the continuous phase, and
a bonding agent for mechanically coupling the one or more polymer chains to the one or more carbon nanotubes, the bonding agent joined to the polymer chain and non-covalently bonded to the carbon nanotube.

2. The composite of claim 1, wherein each carbon nanotube is aligned substantially parallel to one another.

3. The composite of claim 2, wherein a modulus of the composite material along a direction of the alignment of the one or more carbon nanotubes is at least about 250 GPa at 25 C.

4. The composite of claim 1, wherein the composite material is bio-compatible.

5. The composite of claim 1, wherein the one or more carbon nanotubes comprise from about 0.1 to about 20% by weight of the composite.

6. The composite of claim 1, wherein the bonding agent comprises a multifunctional molecule that includes a planar pyrenyl group.

7. The composite of claim 1, wherein the one or more polymer chains are selected from rubber, polyester, polystyrene, latex, polyethylene, epoxies, polyacrylates, or blends or combinations thereof.

8. The composite of claim 1, wherein the one or more polymer chains comprise a biocompatible polymer selected from silicone elastomers, poly(ethylene-co-vinyl acetate), polyacrylates, or combinations thereof.

9. A method for forming carbon nanotube polymer composite materials, comprising the steps of:
mixing a bonding agent having active groups on each of its ends with a polymer solution to form a functionalized polymer solution comprising one of the ends of the bonding agent bonded to the polymer,
blending the functionalized polymer solution with a carbon nanotube material to form a nanotube polymer composite, wherein the other of the ends of the bonding agent is non-covalently bonded to the carbon nanotube.

10. The method of claim 9, wherein the bonding agent is non-covalently bonded to each carbon nanotube using pi-bonds.

11. The method of claim 9, further comprising the step of drawing the composite material, wherein each carbon nanotube becomes aligned substantially parallel to one another.

12. The method of claim 9, wherein the blending step comprises polymerizing the bonding agent into the polymer.

13. The method of claim 9, wherein the carbon nanotube material comprises from about 0.1 to about 20% by weight of the composite.

14. The method of claim 9, wherein the bonding agent comprises a multifunctional molecule that includes a planar pyrenyl group.

15. The method of claim 9, wherein the polymer is selected from rubber, polyester, polystyrene, latex, polyethylene, epoxies, polyacrylates, or blends or combinations thereof.

16. The method of claim 9, wherein the polymer is a biocompatible polymer selected from silicone elastomers, poly(ethylene-co-vinyl acetate), polyacrylates, or combinations thereof.

17. The method of claim 9, further comprising the step of heating the mixture to a suitable temperature to complete polymerization.
